(19) United States
(12) Patent Application Publication
(10) Pub. No.: US 2008/0069918 A1
(43) Pub. Date: Mar. 20, 2008

(54) Distributed Bearing Injection Moulding Device

(75) Inventor: Louis Ramond, Beaumont Sardolles (FR)

Correspondence Address: BLAKELY SOKOLOFF TAYLOR & ZAFMAN, 1279 OAKMEAD PARKWAY, SUNNYVALE, CA, 94085-4040, US

(73) Assignee: DELACHAUX S.A., Gennevilliers (FR)

(21) Appl. No.: 11/665,274

(22) PCT Filed: Oct. 13, 2005
(86) PCT No.: PCT/FR05/02536

§ 371 Date: Jun. 15, 2007

(30) Foreign Application Priority Data
Oct. 15, 2004 (FR) 0410924

(51) Int. Cl. B29C 45/00

(52) U.S. Cl. 425/543

(57) ABSTRACT

The invention relates to a device for injecting thermoplastic material in a liquid state into a mould cavity. A distributor (27) of thermoplastic material in a liquid state, supplying at least one injection nozzle (17), is arranged between a matrix (1), defining at least one mould cavity (4) into which at least one nozzle (17) flows, and a spring release (36), respectively with the aid of a front plate (50) and, preferably, a rear plate (51), of a flat-resting thermally insulating material, in a manner that is as continuous as possible, on a surface (that is as large as possible) of a front surface (26) of the distributor (27) and a rear surface (29) of the matrix (1), preferably on a surface (that is as large as possible) of the rear surface (34) of the distributor (27) and the front surface (37) of the spring release (36) respectively. The matrix (1) is stiffened counter to bending as a result of the stress applied by the injected thermoplastic material and it is possible to reduce the thickness thereof in addition to the length of each nozzle (17).

The present invention relates to a device for injecting thermoplastic material in a liquid state into a mould cavity, comprising, in reference to a determined direction of injection:
a stiff matrix, having a front surface partially defining the mould cavity, a substantially flat rear surface that is substantially perpendicular to the direction of injection, and at least one passage through the matrix from its rear surface to its front surface, in the direction of injection,
as many injection nozzles as through passages, each injection nozzle being disposed inside a respective through passage and bearing toward the front on the rear surface of the matrix, rearwardly projecting on the rear surface of the matrix,
a flat, stiff distributor, having a substantially flat surface, substantially parallel to the rear surface of the matrix and bearing toward the front on each injection nozzle and, if applicable, on the rear surface of the matrix with the aid of localized means for relative positioning, in such a way as to define, around each injection nozzle and, if applicable, localized means for relative positioning, between the front surface of the distributor and the rear surface of the matrix, a substantially continuous, flat front space, the distributor moreover having a substantially flat rear surface, substantially parallel to its front surface, and a peripheral edge connecting its front and rear surfaces to each other,
a supply conduit of the distributor of thermoplastic material in a liquid state, rearwardly projecting on the rear surface of the distributor, and, if applicable, controlled means for gating each injection nozzle, rearwardly projecting on the rear surface of the distributor,
a flat, stiff bolster plate, having a substantially flat front surface, substantially parallel to the rear surface of the distributor and bearing toward the front on the rear surface of the distributor with the aid of bracing means so as to define, around the supply conduit and, if applicable, the gating means, between the front surface of the bolster plate and the rear surface of the distributor, a substantially continuous, flat rear space, the bolster plate and the bracing means being arranged to allow free rearward passage of the supply conduit and, if applicable, the gating means,
stiff peripheral bearing means, toward the front, of a peripheral area of the front surface of the bolster plate on a peripheral area of the rear surface of the matrix, around the peripheral edge of the distributor, defining, with the peripheral edge of the distributor, a continuous peripheral space, communicating with the front and rear spaces, and
rods for mutual assembly of the matrix and the bolster plate with the aid of said peripheral bearing means, substantially parallel to the direction of injection and distributed around said peripheral space.

An injection device of this type is well known in itself, in various embodiments in which one tries to limit the thermal bridges between the distributor on one hand, the matrix and the bolster plate on the other, by limiting the bearing of the front surface of the distributor on the rear surface of the matrix to each injection nozzle and, if applicable, to the localized means for relative positioning, and by limiting the bracing means, thus closely localized, between the rear surface of the distributor and the front surface of the bolster plate, in the direction opposite the direction of injection, to the extension of each injection nozzle.

However, the thermoplastic material in liquid state injected under pressure in the mould cavity applies considerable stress to the front surface of the matrix, such that this stress is essentially exerted in a cantilever with regard to the bearings of the matrix on the distributor, in particular with the aid of nozzles, which results in a tendency by the matrix to bend between these bearings.

Bending of the matrix results in deformation of the front surface of said matrix, meaning on one hand that it results in a lack of geometry of the mould cavity and, consequently, a lack of geometry in the pieces obtained through moulding, and on the other hand, results in a lack of application of this front surface on a similar surface of a counter-matrix, around the cavities, and, consequently, in leaks of thermoplastic material around the cavities and smudges around the pieces obtained.

Transmitted to the bolster plate through the distributor, such bending of the matrix could also result in a gradual creep of the bolster plate, resulting in a loss of tightness between the distributor and the nozzles each time that, as is frequently the case, this tightness is provided by simple mutual longitudinal bearing.

One consequently seeks to offset this tendency to bend:
on one hand, by giving the matrix a thickness able to grant it the necessary stiffness,
on the other hand, when several injection nozzles are planned, by distancing these various nozzles from each other enough to affect this stiffness of the matrix as little as possible.

One does, of course, obtain sufficient stiffness of this matrix, and one can guarantee the geometric quality of the pieces obtained, limit the need for deburring of these pieces and reduce losses of thermoplastic material, but at the expense
of a significant thickness and, consequently, on one hand of significant weight of the matrix and the injection device in its entirety, meaning also of an over-dimensioning of the opening and closing means of the moulds, and on the other hand a great length of the nozzles, meaning also a certain difficulty in maintaining a substantially uniform temperature of the thermoplastic material in a liquid state passing through them, and
of a dispersion of the various injection nozzles, which has consequences both when one uses several injection nozzles to mould one large piece and when one uses several injection nozzles to produce a respective small piece, in the first case by not allowing moulding of certain complex forms, which would require, at least locally, a more significant density of injection nozzles, and, in the second case, by limiting the number of nozzles, meaning of cavities and consequently of pieces molded at one time, for given dimensions of the front surface of the matrix.

To try to correct these drawbacks, Japanese patent application JP-A-05 18 5471 proposes an injection device of the type indicated in the preamble, comprising moreover a front plate of a thermally insulating material, resting flat in a manner that is as continuous as possible, against a surface (that is as large as possible) of the rear surface of the matrix and the front surface of the distributor, around each injection nozzle, to fill said front space as much as possible, and, by way of bracing means between the distributor and the bolster plate, a rear plate of a thermally insulating material, also resting flat in a manner that is as continuous as possible, against a surface (that is as large as possible) of the rear surface of the distributor and the front surface of the bolster plate, around sealing means, to fill said rear space as much as possible, such that the stress applied by the thermoplastic material injected in the mould cavity to the front surface of the matrix is distributed in a manner that is as uniform as possible, through the rear surface of the this, on the front surface of the distributor and that the latter transmits them itself to the bolster plate in a manner that is also as uniformly distributed as possible by its rear surface.

However, in the device described in the aforementioned Japanese patent application, the peripheral bearing means maintain a traditional design, meaning comprising a stiff clamp assembly having a front surface resting flat against the peripheral area of the rear surface of the matrix and a rear surface resting flat against the front surface of the bolster plate.

However, even if one chose an insulating material that is as incompressible as possible for the front and rear plates, the generally metallic material used to produce the stiff clamp assembly is still less compressible and, insofar as the transmission of the stress in question from the matrix to the distributor, then from the distributor to the bolster plate, with the aid of the front and rear plates, is applied cantilever in relation to the bearing offered to the matrix by this stiff clamp assembly and in relation to the bearing offered to this stiff assembly by the bolster plate, this stress still tend to result in bending of the matrix and possibly of the distributor, with all of the aforementioned drawbacks that may result from such bending.

The goal of the present invention is to more effectively resolve these drawbacks and, to this end, the present invention proposes an injection moulding device of the type indicated in the preamble, comprising, as suggested by the aforementioned Japanese patent application, a front plate of a insulating thermoplastic material, resting flat in a manner that is as continuous as possible, against a surface (that is as large as possible) of the rear surface of the matrix and the front surface of the distributor, around each injection nozzle and, if applicable, localized means for relative positioning, to fill said forward space as much as possible, said front plate being substantially incompressible parallel to the direction of injection under normal injection conditions, this device being characterized in that said peripheral bearing means comprise a stiff clamp assembly having a front surface coplanar with the front surface of the distributor and a peripheral part of the front plate, resting flat in a manner that is as continuous as possible, around rods, toward the front against a surface (that is as large as possible) of the peripheral area of the rear surface of the matrix and toward the rear against the front surface of the clamp assembly.

One thereby makes the bearing mode of the rear surface of the matrix against the distributor, on one hand, and against the stiff clamp assembly, on the other hand, uniform, which practically eliminates any transmission of cantilevered stress between them as a result of the stress applied to the front surface of the matrix by the injected thermoplastic material and any tendency of the matrix to bend.

In these conditions, whereas the bolster plate always remains dimensioned to resist all of the stress applied in this way by the thermoplastic material to the front surface of the matrix, it is possible to substantially reduce the thickness of this matrix between its front and rear surfaces and, if desired, to bring the various injection nozzles closer to each other.

Thus, on one hand, it is possible to considerably lighten the injection device, use less powerful means for opening and closing moulds, shorten the nozzles, simplify the means related to heating and thermal regulation and, consequently, to reduce the cost of moulding facilities and, on the other hand, it is possible either to mould large pieces using several injection nozzles by placing these nozzles, if necessary, much closer to each other to meet the needs of a specific geometry of these pieces, meaning to produce, by injection moulding, pieces having a geometry seeming, until now, difficult to imagine producing using this procedure, or to simultaneously produce a larger number of small pieces implementing only one respective injection nozzle by bringing the various nozzles closer together and consequently anticipating a greater number of nozzles and corresponding cavities, at dimensions identical to the front surface of the matrix.

Nevertheless, the choice of a thermally insulating material for the front plate and for the possible rear plate makes it possible to limit the thermal exchanges between the distributor on one hand, and the matrix and bolster plate on the other hand, in a satisfactory manner.

One could moreover maintain the traditional design of bracing means between the distributor and the bolster plate, meaning localized positioning of the bracing means between them; in this case, however, only the front plate and the distributor would contribute to stiffening the matrix against bending.

One consequently prefers an embodiment of the device according to the invention in which, in a known way and as in the device described in the aforementioned Japanese patent application, the bracing means between the rear surface of the distributor and the front surface of the bolster plate are made up of a rear plate of a thermally insulating material, resting flat in a manner that is as continuous as possible, against a surface (as large as possible) of the rear surface of the distributor and the front surface of the bolster plate, around the supply conduit and, if applicable, around gating means, to fill said rear space as much as possible, and this rear plate is substantially incompressible parallel to the direction of injection under normal injection conditions, and in which one also makes uniform the bearing of the distributor and the stiff clamp assembly against the front surface of the bolster plate, such that the rear plate and the bolster plate also contribute to stiffening the matrix counter to bending, in a manner one will easily understand is favorable to it.

To this end, according to a preferred embodiment of the device according to the invention, said peripheral bearing means comprise a stiff clamp assembly having a rear surface coplanar with the rear surface of the distributor and a peripheral part of the rear plate, resting flat in a manner that is as continuous as possible, around rods, toward the rear against a surface (as large as possible) of the peripheral area of the front surface of the bolster plate and toward the front against the rear surface of the clamp assembly.

The device according to the invention is then presented as a superposition of layers made up respectively of the matrix, the front plate, the distributor and the clamp assembly, around this distributor, the rear plate and the bolster plate, each of which may have homogenous characteristics in particular in terms of compressibility, or more specifically incompressibility, parallel to the direction of injection, reference being made the normal injection conditions, and which therefore work under uniform respective conditions, in a manner that is completely favorable to a reduction, or even an elimination, of risks of deformation. This superposition of layers, linked to each other by rods, is practically exempt from gaps, which allows them to cooperate in order to present sufficient stiffness for a reduced overall thickness with regard to that of the injection devices having a traditional design, this thickness being measured parallel to the direction of injection.

In the multilayer device constituted in this way, the matrix is thermally insulated from the distributor, the distributor being thermally insulated from the bolster plate and, insofar as the front and rear plates extend between the clamping unit and the matrix or the bolster plate respectively, this thermal insulation of the distributor with regard to the matrix and the bolster plate also concerns the clamping unit.

One can moreover thermally insulate the distributor from the clamp assembly if, as is preferred, the device according to the invention comprises moreover a peripheral envelope of a thermally insulating material, filling said continuous peripheral space, placed in continuous relation with the front and rear plates, and having, parallel to the direction of injection, a stiffness equal to that of the distributor and the bearing means.

One then creates continuous thermal insulation between the distributor, which one makes sure is maintained at a sufficiently high temperature for the thermoplastic material to remain there in a liquid state and which one generally equips, to this end, with heating means, and a comparatively cold envelope formed around the distributor by the matrix, the bolster plate and the stiff clamping unit, these generally being equipped with cooling means.

The continuity of the peripheral envelope with the front and rear plates may result from a simple frontward bearing of the peripheral envelope on the front plate and rearward bearing on the rear plate and the choice of a stiffness for the peripheral envelope more or less equal to that of the distributor and bearing means makes it possible to avoid disturbing the distribution of stress effect achieved according to the present invention.

Other characteristics and advantages of a device according to the invention will be seen in the description below, relative to a non-exhaustive example of an embodiment, as well as the annexed drawings, which accompany this description.

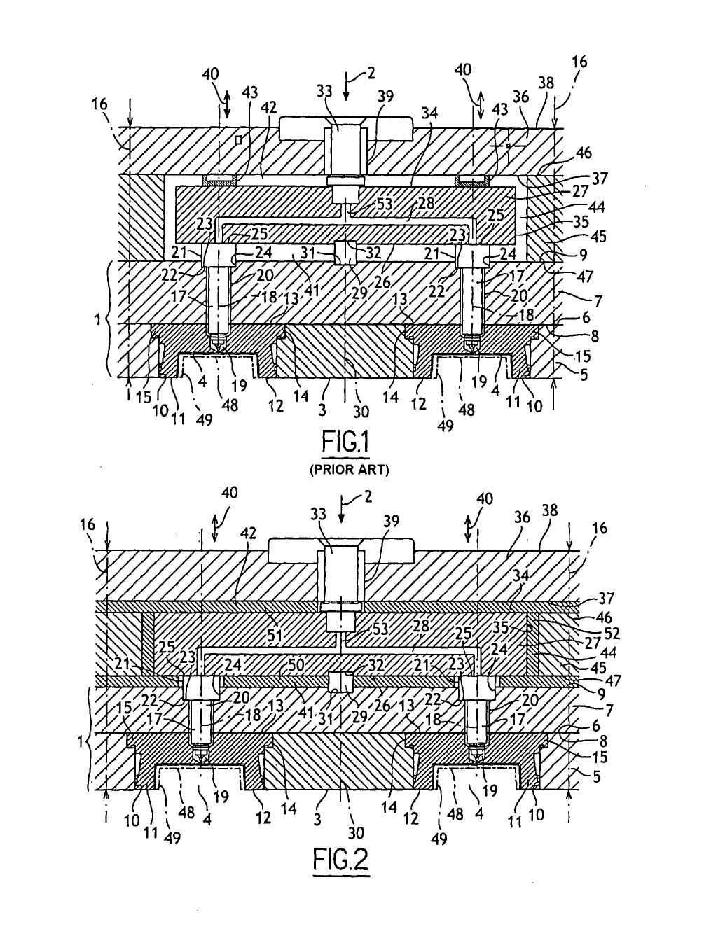

FIG. 1 shows an injection device from the prior art, in cross-section on a plane parallel to the direction of injection.

FIG. 2 shows a similar view of an injection device according to the present invention.

Given what one finds in the device according to the invention, as it is illustrated in FIG. 2, the same components as in a traditional injection device, the same numerical references will be used to describe these components.

In its embodiment according to the invention as in its embodiment according to the prior art, the device illustrated as a non-exhaustive example is intended to simultaneously manufacture, by injection moulding, several identical products, here namely two identical products such as caps for water bottles, household detergent products or similar products; it is understood, however, that the present invention could also be applied to moulding a single piece of a more substantial size than that of a cap, or any other piece, by implementing only one injection nozzle or several injection nozzles.

In its two versions illustrated in FIGS. 1 and 2 respectively, the injection device thus comprises a stiff matrix 1, which, in reference to a determined direction 2 of injection, which will serve as a reference for the notions of front and rear for the whole of this description, has a front surface 3, flat, for example, here with two depressed moulding cavities 4, for example identical to each other, or more generally with as many mould cavities as one has products one wishes to mould simultaneously.

As is well known by the skilled practitioner, the matrix 1 is made up by stacking, flat, parallel to the direction 2 of multiple flat plates, namely in the illustrated example of a front plate 5 having two primary flat surfaces, parallel to each other and perpendicular to the direction 2, to an extent of the front surface 3 of the matrix 1 and a rear surface 6, and a rear plate 7 also having two primary flat surfaces, parallel to each other and perpendicular to the direction 2, to an extent of a flat front surface 8, in a manner that is as continuous as possible, against the rear surface 6 of the front plate 5 and of a rear surface 9 which constitutes a rear surface for the matrix 1 considered in its entirety.

The two plates 5 and 7 also have an exterior peripheral edge, not illustrated, which defines an exterior peripheral edge for the matrix 1.

At the site of each cavity 4, the plate 5 is pierced parallel to the direction 2, all the way through, meaning from its rear surface 6 to its front surface 3, with a respective housing 10 for a respective insert 11 forming the cavity 4 as such, each insert 11 having, toward the front, around the respective cavity 4, a flat surface 12 coplanar with the front surface 3 of the matrix 1, or of the plate 5, and toward the rear a rear surface 13 coplanar with the rear surface 6 of the front plate 5, in such a way as to push, like this last part, rearward, on the front surface 8 of the plate 7. The interlocking of a peripheral rib 14 which each insert 11 has in the immediate vicinity of this rear surface 13, in a peripheral groove 15 located complementarily in each housing 10, in the immediate vicinity of the rear surface 6 of the plate 5, makes it possible to immobilize each insert 11 in relation to the plates 5, 7 by clipping between these latter pieces parallel to the direction 2, for a mutual assembly of the plates 5, 7 with the aid of rods 16, parallel to the direction 2, which will be described below.

Such an assembly is well known by the skilled practitioner and consequently does not require further description.

Likewise, in a manner well known by the skilled practitioner, which will not be described in detail, each cavity 4 is related to a respective injection nozzle 17 of the thermoplastic material in a liquid state, having clearly understood that nozzles 17 may be related to a same cavity 4, in particular in the case of a unique cavity 4.

The nozzle 17 is disposed according to a respective axis 18 which is oriented parallel to the direction 2 and, in the illustrated example, advantageously constitutes an axis of symmetry for the corresponding cavity 4 as well as for the corresponding insert 11 in its entirety.

Each nozzle 17 is equipped with heating and temperature regulation means, not illustrated, in conditions well known by the skilled practitioner, in order to maintain the thermoplastic material in the liquid state throughout injection.

To receive the corresponding nozzle 17, each insert 11 and, coaxially to each insert 11 respectively, the plate 7 are pierced with a respective passage 19, 20 which goes through them following the axis 18, meaning from the rear surface 13 toward the cavity 4 and from the rear surface 9 toward the front surface 8, respectively, in the direction 2.

In an extreme rear area, each nozzle 17 has an enlargement 21, in a radial direction in relation to the respective axis 18, this enlargement 21 defining, toward the front, an annular step 22 perpendicular to the respective axis 18 and turned toward the front. Through this step 22, located at an intermediary level between the surfaces 9 and 8 of the plate 7, each nozzle 17 bears toward the front on an annular step 23 positioned complementarily, depressed, in the rear surface 9 of the plate 7, this step 23 being turned toward the rear and constituting the bottom of an enlarged area 24, perpendicular to the respective axis 18, that each passage 20 has in the immediate vicinity of its connection to the rear surface 9 of the rear plate 7. The bearing of the step 22, toward the front, on the corresponding step 23 attaches each nozzle, parallel to the direction 2, with regard to the plate 7, to the plate 5, to the corresponding cavity 4, and a cooperation between the enlargement 21 of each nozzle 17 and the enlarged area 24 of the corresponding passage 20, perpendicular to the corresponding axis 18, locally attaches the nozzle 20 in a position perpendicular to this axis 18, with regard to the plates 7 and 5 as well as with regard to the corresponding cavity 4; in a manner not illustrated, means may also be anticipated in each insert 11 to ensure the coaxial nature of the respective nozzle 17.

In a manner that is also known, each nozzle 17 projects rearwardly in relation to the surface 9 of the plate 7, namely by its enlargement 21 which is defined toward the rear by a flat rear surface 25 which is oriented perpendicular to the corresponding axis 18 and is located, for all of the nozzles 17, at a same distance from the rear surface 9 of the plate 7, behind this plate, parallel to the direction 2. In other words, the rear surfaces 25 of the various nozzles 17 are mutually coplanar and parallel to the rear surface 9 of the rear plate 7.

In a manner well known in itself, washers forming a spring may be inserted between the steps 22 and 23 to elastically push each nozzle 17 toward the rear with regard to the plate 7, in particular when one is using a simple rearward bearing of each surface 25 against a flat front surface 26, perpendicular to the direction 2, of a distributor 27 disposed in the rear of the plate 7 to ensure tightness counter to a passage of thermoplastic material in a liquid state, between each nozzle 17 and this distributor 27.

It is understood, however, that the present invention is compatible with other forms of cooperation between the nozzles 17 and the distributor 27, and for example with the integral but removable mounting of each nozzle 17 on the distributor 27, for example by screwing.

The front surface 26 of the distributor 27 is thus placed parallel to the rear surface 9 of the plate 7, behind this plate 7, and covers the rear surfaces 25 of all of the nozzles 17 in a manner that is coplanar.

A network of channels 28 is located inside the distributor 27, said channels 28 distributing the thermoplastic material in the liquid state between the various nozzles 17, and means are anticipated to have each of the channels 28 flow toward the front and toward the respective corresponding nozzle 17, at least approximately according to the axis 18 of this. As a non-exhaustive example of such relative positioning means, FIGS. 1 and 2 illustrate a pin 29 disposed according to an axis 30 parallel to the axes 18 and disposed between these axes, at the same distance from each of them, this pin 29 being complementarily engaged, toward the front and the rear respectively, in a blind cavity 31 complementarily located in the rear surface 9 of the plate 7, following the axis 30, and in a blind cavity 32 complementarily located in the front surface 26 of the distributor 27, following the axis 30. Depending on the case, more than one pin 29, thus cooperating with a respective cavity 31 of the plate 7 and a respective cavity 32 of the distributor 27, may be anticipated in a manner well known by the skilled practitioner.

Following the axis 30, the network of channels 28 of the distributor 27 is connected, by a channel 53 of this distributor 27, to a supply conduit 33 of the distributor 27 in thermoplastic material in a liquid state, this conduit 33 also being disposed according to the axis 30 and projecting rearwardly in relation to a rear surface 34 of the distributor 27, said rear surface 34 being flat and parallel to the surface 26.

The form of cooperation between the conduit 33 and the distributor 27 is well known by the skilled practitioner and will not be explained in detail. Likewise, this conduit 33, like the distributor 27, is provided with regulated heating means which are well known by the skilled practitioner and have not been illustrated.

Perpendicular to the direction 2, the front 26 and rear 34 surfaces of the distributor 27 have dimensions smaller than those of the rear surface 9 of the plate 7 and are connected to each other, between the rods 16, by a peripheral edge 35 which, thus, is placed retracted toward the axis 30 and the axes 18 with regard to the rods 16.

Behind the distributor 27 is a flat bolster plate 36 perpendicular to the direction 2 and having, toward the rear surface 34 of the distributor 27, a front surface 37 which is flat and parallel to the surface 34 but has, perpendicular to the direction 2, dimensions greater than those of this surface 34, namely substantially identical to those of the rear surface 9 of the plate 7 or of the front surface 3 of the plate 5.

Toward the rear, the bolster plate 36 is defined by a rear surface 38 which, in the illustrated example, is also flat and perpendicular to the direction 2 and which has, perpendicular to this direction 2, dimensions substantially identical to those of the surface 37.

Following the axis 30, meaning coaxially to the supply conduit 33, the bolster plate 36 is pierced all the way through, meaning from its rear surface 38 to its front surface 37, with a passage 39 allowing it to be freely crossed by the conduit 33. Likewise, when the nozzles 17 are of a controlled gating type, it is pierced through, following each axis 18, by a channel not illustrated also allowing free passage, parallel to the direction 2, for gating means of the respectively corresponding nozzle 18, diagrammed in the illustrated example in the form of an extension of each axis 18 up to the rear of the rear surface 38 of the bolster plate 36; this then advantageously has, on this surface 38, controlled means for causing the passage of gating means from one to the other from a sealed position of the corresponding nozzle 17 and from an open position of this nozzle 17, as diagrammed by a double arrow 40 parallel to the direction 2; such an assembly is well known in itself by the skilled practitioner, and will not be described any further. It is understood that the nozzles 17 may also be provided without gating means, in a manner still compatible with the implementation of the present invention.

Like the front surface 26 of the distributor 27 is spaced from the rear surface 29 of the plate 7, by allowing a flat space 41 to remain with regard to this, said flat space 41 being perpendicular to the direction 2 and continuous if one excepts its passage through the enlarged area 21 of the nozzles 17 and by the positioning pin 29, the front surface 37 of the bolster plate 36 is rearwardly spaced from the rear surface 34 of the distributor 27, and allows a flat space 42 to remain with regard to this surface 34, said flat space 42 being perpendicular to the direction 2 and continuous if one excepts its passage through the supply conduit 33 and, if applicable, through the gating means of the various nozzles 17.

In the prior art as illustrated in FIG. 1, the space 42 is maintained by imposing, between the surface 37 and 34, following each axis 18, a respective closely localized stiff brace 43, perpendicular to the direction 2, in order to reduce the thermal bridges between the rear surface 34 of the distributor 27 and the front surface 37 of the bolster plate 36. The space 42, around the supply conduit 33, around potential gating means for the nozzles 17 and braces 43, defines an air gap, and the same is true for the space 41 between the enlargements 21 of the nozzles 17 and the centering pin 29 and around them.

Likewise, all around the peripheral edge 35 of the distributor 27 is a continuous peripheral space 44 which communicates with the spaces 41 and 42 and defines, like them, in the prior art, an air gap which contributes to the thermal insulation of the distributor 27.

Around this, in the direction of a distancing in relation to the axis 30, the space 44 is defined by peripheral bearing means of a peripheral area of the front surface 37 of the bolster plate 36 toward the front on a peripheral area of the rear surface 9 of the matrix 1, under the effect of rods 16 which act on the bolster plate 38 and on the matrix 1 in a direction bringing them closer to each other through these peripheral bearing means and may have various forms and designs, namely, for example, the form of tie bolts, parallel to the direction 2, of the bolster plate 38 to the peripheral bearing means, from the plate 7 to these means and from the plate 5 to the plate 7, this example not, of course, being exhaustive in any way.

In the prior art, as shown in FIG. 1, the peripheral bearing means are made up of a stiff clamp assembly 45 made up of massive pieces, each of which has a flat rear surface 46, perpendicular to the direction 2, on which the front surface 37 of the bolster plate 36 rests flat in this direction 2, and a front surface 47 which is also flat and perpendicular to the direction 2, this surface 47 resting flat in this direction 2 on the rear surface 9 of the plate 7.

With the bolster plate 36 and the matrix 1, the stiff clamp assembly 45 forms, around the distributor 27, a comparatively cold envelope, in a thermal exchange relationship with the ambient air and most often provided with cooling means which are not illustrated, for example in the form of channels for circulating a cooling liquid.

In these conditions, during injection, meaning when one injects the thermoplastic material in a liquid state in the various closed cavities 48, defined in each cavity 4 by a respective counter-cavity 49 of a counter-matrix that is not illustrated, the pressure applied by the thermoplastic material on each cavity 4, meaning on each insert 11, results in the application, to the plate 7, of mostly cantilevering stress with regard to the comparatively limited rearward bearings of the nozzles 17 against the front surface 26 of the distributor, as well as in relation to the respective bearings of the pin 29 against the distributor 27 and of the rear surface 9 of the plate 7 against the front surface 47 of the clamp assembly 45.

The result is a tendency by the plate 7 to bend toward the rear between the bearings thus constituted, and it is by giving the plate 7 a substantial thickness, between its front 8 and rear 9 surfaces, requiring an appropriate length of the nozzles 17 parallel to the direction 2, that one provides this plate 7 with sufficient mechanical resistant counter to such bending.

In the case of a device according to the present invention, as illustrated in FIG. 2, on the other hand, the space 41 is integrally filled, around the enlargements 21 of the nozzles 17 and the pin 29, by a front plate 50 of a thermally insulating material, resting flat in a manner that is as continuous as possible, on a surface (that is as large as possible) of the rear surface 9 of the plate 7, toward the front, and on a surface (that is as large as possible) of the front surface 26 of the distributor 27, toward the rear; moreover, in such a device, a peripheral part of this plate 50 extends between the front surface 47 of the stiff clamp assembly 45, then coplanar with the front surface 26 of the distributor 27, and the corresponding peripheral area of the rear surface 9 of the plate 7, up to the exterior periphery of this, and it also being subject to the tightening effect achieved by the rods 16.

The material making up the plate 50 is chosen so as to be substantially incompressible parallel to the direction 2 under normal injection conditions, with the result that the plate 50 also ensures, in the same way as the enlargements 21 of the nozzles 17 and the pin 29, a transmission of stress, in the opposite direction of the direction 2, from the front surface 9 of the plate 7 to the front surface 26 of the distributor 27 just as, insofar as the plate 50 extends between a peripheral area of the rear surface 9 of the plate 7 and the front surface 47 of the stiff clamp assembly 45, it ensures transmission of stress from the plate 7 to this assembly 45 in the direction opposite from the direction 2.

Thus, as the skilled practitioner will easily understand, one obtains a distribution over the entirety of the front surface 26 of the distributor 27 and on the front surface 47 of the assembly 45, stress which would tend to make the plate 7 bend, with the result that the distributor 27 and the unit 45 contribute to the stiffening of said plate 7.

One can therefore reduce the thickness of the plate 7 as well as the length of the nozzles 17, in comparison with the prior art, without having to fear bending of the plate 7 under the effect of the stresses applied to it by the thermoplastic material in a liquid state, injected in the cavities 48. One may also bring the passages 20 located in the plate 7 closer together in order to receive the nozzles 17, meaning these nozzles 17 as well as the corresponding cavities 4, which makes it possible to increase the number of cavities 4 with identical dimensions of the injection device perpendicular to the direction 2.

Naturally, the distributor 27 could then tend to bend between the braces 43 if these braces were kept, since it would then be compelled toward the rear, in cantilever in relation to these braces 43.

Consequently, in the device according to the invention, one prefers to replace the localized braces 43 in the space 42 by a plate 51 similar in all ways to the plate 50, meaning made of a thermally insulating material, substantially incompressible parallel to the direction 2 under normal injection conditions, and one sizes this plate 51 such that it rests flat, in a manner that is as continuous as possible, on a surface (that is as large as possible) of the rear surface 34 of the distributor 35 and of the front surface 37 of the bolster plate 36, around supply conduits 39 and possible gating means for the nozzles 17, to between the rear surface 46 of the stiff clamp assembly 45, then coplanar with the rear surface 34 of the distributor 27, and a peripheral area of the front surface 37 of the bolster plate, by a peripheral part of the plate 51 then also concerned by the tightening applied by the rods 16.

It is then that a compact unit, made up by a superposition of the plate 7, the plate 50, the distributor 27 and the stiff clamp assembly 45, the plate 51 and the bolster plate 38 which cooperates to resist bending under the effect of stresses applied to the cavities 4, inside the cavities 48, by the thermoplastic material injected into said cavities 48, and obtaining a sufficient stiffness in the plate 5 and the inserts 11 defining the cavities 4 can be achieved at the expense of a total thickness significantly lower than the unit thus formed between the front surface 3 of the plate 5 and the rear surface 38 of the bolster plate 36.

The choice of an appropriate material for the plate 50 and 51 makes it possible to obtain, moreover, thermal insulation at least as good as in the prior art around the distributor 27, and one may improve this thermal insulation by filling the space 44 using a peripheral envelope 52 of a thermally insulating material, peripherally continuous and in continuous relation with the plates 50 and 51, taking care to chose the constitutive material for this peripheral envelope 52 such that it has a compressibility, parallel to the direction 2, at least equal to that of the distributor 27, meaning a stiffness at most equal to that of this distributor 27 against a compression parallel to the direction 2.

Naturally, this reference to the distributor 27 concerning the potential compressibility of the peripheral envelope 52 must extend into the general context of this application, in which it is understood that the distributor 27, like the matrix 6, the bolster plate 38, the stiff clamp assembly 45 and the plates 41 and 42, is stiff under normal injection conditions, meaning that it resists bending at least when it is integrated into the compact assembly made up by the indicated superposition and moreover resists the compressive stress to which it may be subjected during injection of the thermoplastic material in a liquid state in the cavities 14 or the cavities 48. In this respect, these components shared by a device according to the invention and a device according to the prior art may be made of the same materials as in the prior art, namely steel, for example. The plates 41 and 42 may be made of a fibers glass cloth, in layers superimposed and linked to each other by coating with a thermosetting resin, such a constitution only, however, being indicated as a non-exhaustive example.

A skilled practitioner will easily understand that the embodiment of an injection device according to the invention that has just been described only constitutes one non-exhaustive example with regard to which one could not anticipate many variations without leaving the framework of the present invention, in particular in terms of the number of cavities such as 4, the number of nozzles such as 17 related to each cavity such as 4, the general design of the nozzles 17, of the distributor 27 and of its supply conduit 33, and in terms of choice and provision relative to the respective components of the matrix 1, the bolster plate 38 and the stiff clamp assembly 45.

1-3. (canceled)

4. Device for injecting thermoplastic material in a liquid state into a mould cavity (4), comprising, in reference to a determined direction (2) of injection:
a stiff matrix (1), having a front surface (3) partially defining the mould cavity (4), a substantially flat rear surface (9) substantially perpendicular to the direction of injection (2), and at least one passage (19, 20) going through the matrix (1) from its rear surface (9) to its front surface (3), in the direction of injection (2),
as many injection nozzles as through passages (19, 20), each injection nozzle (17) being disposed inside a respective through passage (19, 20) and bearing frontward on the rear surface (9) of the matrix (1), forming a rearward projection on the rear surface (9) of the matrix (1),
a flat, stiff distributor (27) having a substantially flat front surface (26) substantially parallel to the rear surface (9) of the matrix (1) and bearing frontward on each injection nozzle (17) and, if applicable, on the rear surface (9) of the matrix (1) with the aid of localized means (29) for relative positioning, in such a way as to define, around each injection nozzle (17) and, if applicable, around localized means (29) for relative positioning, between the front surface (26) of the distributor and the rear surface (9) of the matrix (1), a flat, substantially continuous front space (41), the distributor (27) moreover has a substantially flat rear surface (34), substantially parallel to its front surface (26), and a peripheral edge (35) connecting its front and rear surfaces (34) to each other,
a supply conduit (33) of the distributor (27) of thermoplastic material in a liquid state, forming a rearward projection on the rear surface (34) of the distributor, and, if applicable, controlled gating means of each injection nozzle (17), forming a rearward projection on the rear surface (34) of the distributor (27),
a flat, stiff bolster plate (36) having a substantially flat front surface (37) substantially parallel to the rear surface (34) of the distributor (27) and bearing frontward on the rear surface (34) of the distributor (27) with the aid of bracing means (51) so as to define, around the supply conduit (33) and, if applicable, around gating means, between the front surface (37) of the bolster plate (36) and the rear surface (34) of the distributor (27), a flat, substantially continuous rear space (42), the bolster plate (36) and the bracing means (51) being arranged to allow free rearward passage of the supply conduit (33) and, if applicable, of gating means,
stiff means (45, 50, 51) for frontward peripheral bearing of a peripheral area of the front surface (37) of the bolster plate (36) on a peripheral area of the rear surface (9) of the matrix (1), around the peripheral edge (35) of the distributor (27), defining, with the peripheral edge (35) of the distributor, a continuous peripheral space (44) communication with the front (41) and rear (42) spaces, and
rods (16) for mutual assembly of the matrix (1) and bolster plate with the aid of said peripheral bearing means (45, 50, 51), substantially parallel to the direction of injection and distributed around said peripheral space (44),
a front plate (50) of a thermally insulating material, resting flat in a manner that is as continuous as possible, against a surface (that is as large as possible) of the rear surface (9) of the matrix (1) and of the front surface (26) of the distributor (27), around each injection nozzle (17) and, if applicable, around localized means (29) for relative positioning, to fill said front space (41) as much as possible, said front plate (50) being substantially incompressible parallel to the direction of injection under normal injection conditions,
wherein said peripheral bearing means (45, 50, 51) comprise a stiff clamp assembly (45) having a front surface (47) coplanar with the front surface (26) of the distributor (27) and a peripheral part of the front plate (50), resting flat, in a manner that is as continuous as possible, around rods (16), toward the front against a surface (that is as large as possible) of the peripheral area of the rear surface (9) of the matrix (1) and toward the rear against the front surface (47) of the clamp assembly (45).

5. The injection device of claim 4, wherein the bracing means (51) are made up of a rear plate (51) of a thermally insulating material, resting flat in a manner that is as continuous as possible, against a surface (that is as large as possible) of the rear surface (34) of the distributor (27) and the front surface (37) of the bolster plate (36), around the supply conduit (33) and, if applicable, around gating means, to fill said rear space (42) as much as possible, in that the rear plate (51) is substantially incompressible parallel to the direction of injection under normal injection conditions, and in that said peripheral bearing means (45, 50, 51) comprise a stiff clamp assembly (45) having a rear surface (46) coplanar with the rear surface (34) of the distributor (27) and a peripheral part of the rear plate (51), resting flat, in a manner that is as continuous as possible, around rods (16), toward the rear against a surface (that is as large as possible) of the peripheral area of the front surface (37) of the bolster plate (36) and toward the front against the rear surface (46) of the clamp assembly (45).

6. The injection device of claim 5, comprising a peripheral envelope (52) of a thermally insulating material, filling said continuous peripheral space (44), placed in continuous relation with the front (50) and rear (51) plates, and having, parallel to the direction of injection (2), a stiffness at most equal to that of the distributor (27) and bearing means (45, 50, 51).
